(19) United States
(12) Patent Application Publication
(10) Pub. No.: US 2024/0038971 A1
(43) Pub. Date: Feb. 1, 2024

(54) SECONDARY BATTERY NEGATIVE ELECTRODE, MANUFACTURING METHOD OF SECONDARY BATTERY NEGATIVE ELECTRODE, AND SECONDARY BATTERY

(71) Applicant: TOYOTA JIDOSHA KABUSHIKI KAISHA, Toyota-shi (JP)

(72) Inventors: Takayuki UCHIYAMA, Susono-shi (JP); Jun YOSHIDA, Susono-shi (JP); Tetsuya WASEDA, Susono-shi (JP)

(21) Appl. No.: 18/313,455

(22) Filed: May 8, 2023

(30) Foreign Application Priority Data
Jul. 28, 2022 (JP) 2022-120688

(51) Int. Cl. H01M 4/36; H01M 4/62; H01M 4/1395; H01M 4/04

(52) U.S. Cl. CPC H01M 4/366; H01M 4/621; H01M 4/1395; H01M 4/043; H01M 2004/027

(57) ABSTRACT

The secondary battery negative electrode of the present disclosure includes an active material layer, the active material layer includes a sulfide solid electrolyte and composite particles as an active material, the composite particles include a plurality of porous silicon particles and a binder, and the active material layer has a porosity of more than 15%.

### CROSS-REFERENCE TO RELATED APPLICATION

This application claims priority to Japanese Patent Application No. 2022-120688 filed on Jul. 28, 2022, incorporated herein by reference in its entirety.

### BACKGROUND

### 1. Technical Field

The present application discloses a secondary battery negative electrode, a manufacturing method of a secondary battery negative electrode, and a secondary battery.

### 2. Description of Related Art

A secondary battery negative electrode including a Si active material is known. For example, Japanese Unexamined Patent Application Publication No. 2019-121557 (JP 2019-121557 A) discloses a negative electrode layer used in an all-solid-state battery, in which the negative electrode layer includes a negative electrode active material and a sulfide solid electrolyte, and in which the negative electrode active material is a composite particle including: a plurality of particles containing Si elements; and a binder. A porosity of the negative electrode layer disclosed in JP 2019-121557 A is 15% or less.

Japanese Unexamined Patent Application Publication No. 2021-166153 (JP 2021-166153 A) discloses a method of manufacturing an active material including a gap by extracting Li from a LiSi precursor by using a Li extracting solvent.

### SUMMARY

In the conventional secondary battery negative electrode, there is room for improvement in suppressing a change in thickness of the negative electrode due to expansion and contraction of the active material during charging and discharging, and in reducing resistance of the negative electrode.

One aspect of the present application discloses

a secondary battery negative electrode, the secondary battery negative electrode including an active material layer,
in which the active material layer includes a sulfide solid electrolyte and a composite particle that serves as an active material;
in which the composite particle includes a plurality of porous silicon particles and a binder; and
in which the active material layer has a porosity of more than 15%.

In the secondary battery negative electrode of the present disclosure, when a cross section of the active material layer is observed, at least half of a plurality of the composite particles extracted by the following extracting method may have an aspect ratio of 2.5 or more.

Extraction method: The cross section of the active material layer is observed, the composite particles included in the cross section are extracted in descending order of a cross-sectional area, and the extraction is terminated when a total area of the extracted composite particles exceeds 80% of a total area of all the composite particles included in the cross section.

In the secondary battery negative electrode of the present disclosure, the composite particle may include porous carbon serving as the binder.

Another aspect of the present application discloses a manufacturing method of a secondary battery negative electrode, the manufacturing method including:

acquiring a LiSi precursor including Li and Si;
removing Li from the LiSi precursor to acquire a porous silicon-particle;
acquiring a composite particle including a plurality of the porous silicon particles and a binder;
acquiring an active material mixture including a sulfide solid electrolyte and the composite particle; and
acquiring an active material layer having a porosity of more than 15% by pressing the active material mixture.

The manufacturing method of the present disclosure may include pressing the active material mixture to deform the composite particle, and in this case, when a cross section of the active material layer after pressing is observed, at least half of a plurality of the composite particles extracted by the following extraction method may have an aspect ratio of 2.5 or more.

Extraction method: The cross section of the active material layer is observed, the composite particles included in the cross section are extracted in descending order of a cross-sectional area, and the extraction is terminated when a total area of the extracted composite particles exceeds 80% of a total area of all the composite particles included in the cross section.

The manufacturing method of the present disclosure may include: mixing the plurality of porous silicon particles with an organic component to acquire an intermediate complex; and carbonizing the organic component of the intermediate complex to acquire the composite particle including the porous silicon particles and porous carbon serving as the binder.

Another aspect of the present application discloses secondary battery that includes the secondary battery negative electrode of the present disclosure.

The secondary battery negative electrode of the present disclosure has a small change in thickness of the negative electrode due to expansion and contraction of the active material during charging and discharging. In addition, the secondary battery negative electrode of the present disclosure has a small resistance. The secondary battery including the negative electrode of the present disclosure has a small change in thickness of the negative electrode during charging and discharging, and thus, for example, a change in restraint pressure during charging and discharging is small. Further, the secondary battery including the negative electrode of the present disclosure has, for example, excellent charge and discharge performance due to a small resistance of the negative electrode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a configuration of a negative electrode and a secondary battery;

FIG. 2 shows the relationship between the filling ratio (100-porosity) of the active material layer in the negative electrode and the resistance of the battery;

FIG. 3 shows the relationship between the filling ratio (100-porosity) of the active material layer in the negative electrode and the amount of increase in the constrained pressure of the battery;

FIG. 4A shows an exemplary cross-section of the active material layers observed by SEM;

FIG. 4B shows a binarization of the compound grains (black) and the others (white) for the cross-section shown in FIG. 4A; and

FIG. 4C shows an elliptic approximation of the aspect ratio of each of the composites on the basis of the binarized images in FIG. 4B.

### DETAILED DESCRIPTION OF EMBODIMENTS

### 1. Secondary Battery Negative Electrode

The secondary battery negative electrode of the present disclosure has an active material layer. The active material layer includes a sulfide solid electrolyte and composite particles as an active material. The composite particle includes a plurality of porous silicon particles and a binder. The active material layer has a porosity of greater than 15%.

### 1.1 Active Material Layer

The active material layer includes a sulfide solid electrolyte and composite particles as an active material. The shape of the active material layer is not particularly limited, and may be, for example, a sheet-like active material layer having a substantially flat surface. The thickness of the active material layers is not particularly limited, and may be, for example, 100 nm or more, 1 μm or more, or 10 μm or more, and may be 2 mm or less, or 1 mm or less.

### 1.1.1 Sulfide Solid Electrolyte

The active material layer includes a sulfide solid electrolyte. The sulfide solid electrolyte may be any sulfide capable of conducting carrier ions in the secondary battery. As a specific example of the sulfide solid electrolyte in the case of constituting a rechargeable lithium-ion battery, Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, Li₂S—P₂S₅—GeS₂. Among them, the constituent elements include at least Li, S, and at least one of P, Si, and Ge with high performance, and those including at least Li, S, and P with particularly high performance. The sulfide solid electrolyte may be amorphous or may be crystalline. The sulfide solid electrolyte may be, for example, particulate. Only one sulfide solid electrolyte may be used alone, or two or more sulfide solid electrolytes may be used in combination.

### 1.1.2 Composite Particle

The active material layer includes composite particles as an active material. The composite particle includes a plurality of porous silicon particles and a binder. More specifically, the plurality of porous silicon particles is bonded to each other via a binder, thereby forming composite particles.

### 1.1.2.1 Porous Silicon Particles

The composite particle comprises a plurality of porous silicon particles. The porous silicon particles include silicon having a plurality of voids. There is no particular limitation on the form of voids in the porous silicon particles. The porous silicon particles may be particles comprising nanoporous silicon. Nanoporous silicon refers to silicon in which there are a plurality of pores having pore diameters on the order of nanometers (less than 1000 nm, preferably less than or equal to 100 nm). The porous silicon-particles may include pores having a diametric 55 nm or less. The pores having a diametrical 55 nm or less are hardly crushed by pressing. In other words, porous silicon grains containing pores having diametrical 55 nm or less are easily maintained in porosity even after pressing. For example, pores having a diametric 55 nm or less per 1 g of porous silicon particles may be contained in an amount of 0.21 cc or more, 0.22 cc/g or more, or 0.23 cc/g or more, and may be contained in an amount of 0.30 cc/g or less, 0.28 cc/g or less, or 0.26 cc/g or less. The pore size of 55 nm or less included in the porous silicon particles can be determined by, for example, a nitrogen-gas adsorption method or a DFT method.

The porous silicon particles may have a predetermined porosity. The porosity of the porous silicon particles may be, for example, 1% or more, 5% or more, 10% or more, or 20% or more, and may be 80% or less, 70% or less, 60% or less, 50% or less, 40% or less, or 30% or less. The porosity can be determined, for example, by observing with a scanning electron-microscope (SEM). The number of samples is preferably large, for example 100 or more. The porosity can be an average value determined from these samples.

However, in the secondary battery negative electrode of the present disclosure, voids in the porous silicon particles, voids in the composite particles, voids outside the composite particles, and the like do not need to be distinguished from each other. In the secondary battery negative electrode of the present disclosure, the porosity of the entire active material layer including the voids in the porous silicon particles, the voids in the composite particles, the voids outside the composite particles, and the like may be more than 15%. That is, the size of the porosity of the porous silicon particles, the size of the porosity of the composite particles, and, regardless of the size of the porosity outside the composite particles, if the porosity of the entire active material layer is more than 15%, the negative electrode during charging the effect of suppressing the thickness change can be expected.

The composition of the porous silicon particles is not particularly limited. The ratio of Si element to all the elements contained in the porous silicon-particle may be, for example, not less than 50 mol %, not less than 70 mol %, or not less than 90 mol %. In addition to Si element, the porous silicon particles may contain another element such as a Li element. Other elements include Li elements, Sn elements, Fe elements, Co elements, Ni elements, Ti elements, Cr elements, B elements, P elements, and the like. The porous silicon particles may contain impurities such as oxides. The porous silicon particles may be amorphous or crystalline. The crystalline phase contained in the porous silicon particles is not particularly limited.

The shape and size of the porous silicon particles are not particularly limited. The mean primary particle diameter of the porous silicon particles may be, for example, 30 nm or more, 50 nm or more, 100 nm or more, or 150 nm or more, and may be 10 μm or less, m or less, 3 μm or less, 2 μm or less, or 1 μm or less. The mean secondary particle diameter of the porous silicon particles may be, for example, 100 nm or more, 1 μm or more, or 2 m or more, and may be 20 μm or less, 15 μm or less, or 10 μm or less. Meanwhile, the average primary particle diameter and the average secondary particle diameter can be obtained by observing SEM or the like by an electron microscope, and can be obtained, for example, as an average of the largest ferret diameters of the plurality of particles. The number of samples is preferably large, for example, 20 or more, may be 50 or more, or may be 100 or more. The average primary particle diameter and the average secondary particle diameter can be appropriately adjusted by, for example, appropriately changing the manufacturing conditions of porous silicon particles to be described later or performing a classification process.

### 1.1.2.2 Binder

The composite particles comprise a binder. The binder bonds the plurality of porous silicon particles to each other. The type of the binder is not particularly limited. The binder may be selected from, for example, a butadiene rubber (BR) based binder, a butylene rubber (IIR) based binder, an acrylate butadiene rubber (ABR) based binder, a styrene butadiene rubber (SBR) based binder, a polyvinylidene fluoride (PVdF) based binder, a polytetrafluoroethylene (PTFE) based binder, a polyimide (PT) based binder, a carboxymethyl cellulose (CMC) based binder, a polyacrylate based binder, a polyacrylate ester based binder, and the like. Only one type of conductive aid may be used alone, or two or more types may be used in combination.

The composite particles may include porous carbon as a binder. Porous carbon as a binder can be obtained, for example, by carbonizing various organic components. For example, by mixing a plurality of porous silicon particles and an organic component, bonding the porous silicon particles together with an organic component, and then carbonizing the organic component by heating, a composite particle in which a plurality of porous silicon particles are bonded together via porous carbon is obtained. The proportion of the porous carbon in the entire binder is not particularly limited, and may be, for example, 0% by volume or more, 0% by volume or more, 10% by volume or more, 20% by volume or more, 30% by volume or more, or 40% by volume or more, and may be 100% by volume or less, or 90% by volume or less. When the composite particles contain porous carbon as a binder, the conductivity of the composite particles is improved, and the resistance of the negative electrode tends to be reduced. In addition, even when the porous silicon particles expand or contract, the volume change of the composite particles as a whole is easily relaxed by the voids of the porous carbon, and the thickness change of the negative electrode is easily suppressed. Whether or not the composite particles contain porous carbon as a binder can be determined by an image obtained by observation with an electron microscope or the like or by elemental analysis.

### 1.1.2.3 Ratio of Porous Silicon Particles and Binder Contained in the Composite Particles

The ratio of the porous silicon particles and the binder contained in the composite particles is not particularly limited as long as the ratio is such that the composite particles can be formed. For example, the proportion of the binder in the total of the porous silicon particles and the binder may be 1% by mass or more, 5% by mass or more, or 8% by mass or more, and may be 30% by mass or less, 28% by mass or less, 26% by mass or less, 24% by mass or less, or 22% by mass or less. When the ratio of the binder to the total of the porous silicon particles and the binder is 1% by mass or more and 30% by mass or less, a larger charge/discharge capacity is easily secured.

### 1.1.2.4 Number of Porous Silicon Particles Contained in the Composite Particles

The number of porous silicon particles included in one composite particle is plural. The number of porous silicon particles contained in the composite particles may be, for example, 3 or more, 5 or more, 10 or more, or 50 or more, and may be 1000 or less. The number of porous silicon particles contained in the composite particles can be specified by, for example, an image obtained by observation with an electron microscope or the like or an elemental analysis.

### 1.1.2.5 Particle Size of Composite Particles

The composite particles can be regarded as secondary particles in which a plurality of porous silicon particles are aggregated via a binder. The average particle diameter of the composite particles is not particularly limited. The mean particle diameter of the composite particles may be 100 nm or more, 1 μm or more, 2 μm or more, or 3 μm or more, and may be 20 μm or less, 15 μm or less, or 10 μm or less. The average particle diameter of the composite particles contained in the active material layer can be obtained by observing the composite particles with an electronic microscope such as a SEM, and is obtained, for example, as an average of the maximum ferret diameters of the plurality of composite particles. The number of samples is preferably large, for example, 20 or more, may be 50 or more, or may be 100 or more. Alternatively, only the composite particles are taken out from the active material layer, and the mean particle diameter (D50, median diameter) of the composite particles measured by using a laser diffraction particle distribution measuring device may be 100 nm or more, 1 μm or more, 2 μm or more, or 3 μm or more, and may be m or less, 15 μm or less, or 10 μm or less.

### 1.1.2.6 Shape of Composite Particles

As described below, the active material layer including the sulfide solid electrolyte and the composite particles may be formed by pressing an active material mixture including the sulfide solid electrolyte and the composite particles. In this case, the composite particles may collapse in the pressing direction and have an aspect ratio equal to or higher than a predetermined value. When the composite particles are pressed to a degree having an aspect ratio of a predetermined value or more, the contact resistance in the composite particles, the contact resistance between the composite particles, the contact resistance between the composite particles and other materials, and the like are reduced, and the resistance as a whole of the negative electrode tends to be further reduced. Specifically, from the viewpoint that the resistance of the negative electrode is further reduced, in the secondary battery negative electrode of the present disclosure, when the cross section of the active material layer is observed, half or more (50% or more in number ratio) of the plurality of composite particles extracted by the following extraction method may have an aspect ratio of 2.5 or more.

Extraction method: The cross section of the active material layer is observed, the composite particles included in the cross section are extracted in descending order of the cross-sectional area, and the extraction is terminated when the total area of the extracted composite particles exceeds 80% of the total area of all the composite particles included in the cross section.

The above-described extracting methods may be performed by image analysis based on a cross-sectional image of the active material layers acquired by SEM or the like. In the image analysis, the aspect ratio of each composite particle may be specified by approximating the composite particle included in the image to an ellipse. The extraction of the composite particles and the identification of the aspect ratio by the image analysis of the cross section of the active material layer will be described in more detail in the following examples.

### 1.1.3 Other Ingredients

The active material layer includes at least the above-described sulfide solid electrolyte and composite particles. The active material layer may further optionally include an electrolyte other than the sulfide solid electrolyte, an active material other than the composite particles, a conductive auxiliary agent, a binder other than the composite particles, and the like. Further, the active material layer may contain various additives. The content of each of the active material, the electrolyte, the conductive auxiliary agent, the binder, and the like in the active material layer may be appropriately determined in accordance with the desired battery performance. For example, the entire active material layer (solid content as a whole) as 100 wt %, the content of the above composite particles 40 wt % or more, 45 wt % or more, may be 50 wt % or more or 55 wt % or more, 99 wt % or less, 95 wt % or less, 90 wt % or less or 80 wt % or less it may be. Further, the entire active material layer (solid content as a whole) as 100 wt %, the content of the sulfide solid electrolyte is 1 wt % or more, 5 wt % or more, may be 10 wt % or more or 20 wt % or more, 60 wt % or less, 55 wt % or less, 50 wt % or less or 45 wt % or less it may be.

1.1.3.1 Electrolyte Other than the Sulfide Solid Electrolyte

The electrolyte other than the sulfide solid electrolyte that can be included in the active material layer may be, for example, a solid electrolyte, a liquid electrolyte, or a combination thereof. As the solid electrolyte, one known as a solid electrolyte of a secondary battery may be used. The solid electrolyte may be an inorganic solid electrolyte or an organic polymer electrolyte. In particular, the inorganic solid electrolyte is excellent in ionic conductivity and heat resistance. Examples of the inorganic solid electrolyte other than the sulfide solid electrolyte include lithium lanthanum zirconate, LiPON, Li_{1+X}Al_{X}Ge_{2-X}(PO₄)₃, Li—SiO glasses, and oxide solid electrolytes such as Li—Al—S—O glasses. The electrolytic solution may contain, for example, lithium ions as carrier ions. The electrolytic solution may be, for example, a nonaqueous electrolytic solution. The composition of the electrolytic solution may be the same as that known as the composition of the electrolytic solution of the secondary battery. For example, as the electrolytic solution, a solution obtained by dissolving a lithium salt in an organic solvent such as a carbonate-based solvent at a predetermined concentration can be used. There is no particular limitation on the type of the lithium salt. The proportion of the sulfide solid electrolyte in the entire electrolyte contained in the active material layer may be, for example, 80% by mass or more, 90% by mass or more, or 95% by mass or more, and may be 100% by mass or less.

In the secondary battery negative electrode of the present disclosure, the active material layer may or may not contain a liquid component. The liquid component may be an electrolyte that can function as an electrolyte, or may be one that does not function as an electrolyte (e.g., a lubricating component). In the secondary battery negative electrode of the present disclosure, a plurality of porous silicon particles are bonded to each other via a binder to form composite particles, and the composite particles and the sulfide solid electrolyte are combined with each other, whereby the ion conduction path and the conductive path can be secured even in the absence of the liquid component.

1.1.3.2 Active Materials Other than Composite Particles

Examples of the active material other than the composite particles that can be included in the active material layer include silicon-based active materials such as Si, a Si alloy, and silicon oxide; carbon-based active materials such as graphite and hard carbon; various oxide-based active materials such as lithium titanate; and metallic lithium and lithium alloys. The proportion of the composite particles in the total of the composite particles contained in the active material layer and the active materials other than the composite particles may be, for example, 80% by mass or more, 90% by mass or more, or 95% by mass or more, and may be 100% by mass or less.

### 1.1.3.3 Conductive Aid

Examples of the conductive auxiliary agent that can be included in the active material layers include carbon materials such as vapor-phase carbon fibers (VGCF), acetylene black (AB), Ketjen black (KB), carbon nanotubes (CNT), and carbon nanofibers (CNF); and metallic materials such as nickel, aluminum, and stainless steel. The conductive aid may be, for example, in the form of particles or fibers, and its size is not particularly limited. Only one type of conductive aid may be used alone, or two or more types may be used in combination.

1.1.3.4 Binders Other than Composite Particles

The active material layer may include a binder separately from the composite particles. The binder may be selected from, for example, a butadiene rubber (BR) based binder, a butylene rubber (IIR) based binder, an acrylate butadiene rubber (ABR) based binder, a styrene butadiene rubber (SBR) based binder, a polyvinylidene fluoride (PVdF) based binder, a polytetrafluoroethylene (PTFE) based binder, a polyimide (PI) based binder, a carboxymethyl cellulose (CMC) based binder, a polyacrylate based binder, a polyacrylate ester based binder, and the like. Only one type of conductive aid may be used alone, or two or more types may be used in combination. The binder constituting the composite particles and the binder other than the composite particles may be of the same type or may be of different types.

### 1.1.4 Porosity of the Active Material Layer

In the secondary battery negative electrode of the present disclosure, the active material layer has a porosity of more than 15%. Since the active material layer has such a high porosity, even when the composite particles as the active material expand and contract during charging and discharging, the thickness change of the negative electrode is difficult to increase. The upper limit of the porosity of the active material layer is not particularly limited. In the secondary battery negative electrode of the present disclosure, even when the porosity of the active material layer is large, the resistance can be reduced by the effect of combining the porous silicon particles and the binder, the effect of combining with the sulfide solid electrolyte, and the like. The porosity of the active material layer may be, for example, 50% or less, 45% or less, 40% or less, 35% or less, 30% or less, 25% or less, or 20% or less. The “porosity” of the active material layer is a ratio of the volume of the voids in the active material layer to the entire active material layer. The porosity of the active material layer is specified as follows. That is, when the porosity of the active material layer is A, the sum of the volumes obtained by dividing the weights of the respective materials constituting the active material layer by the true densities of the respective materials is x, and the volume obtained from the dimensions of the actual active material layer is y, the porosity A can be calculated by A (%)=(1−x/y)×100).

1.2 Configuration Other than the Active Material Layer

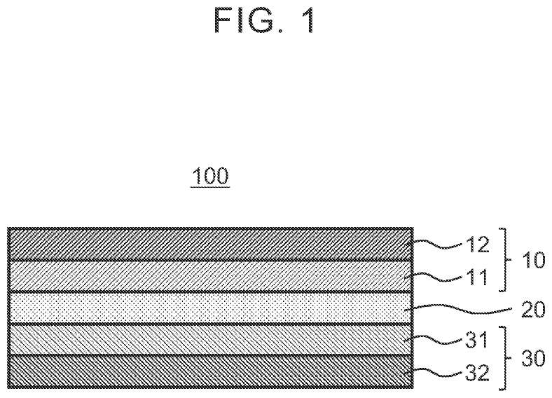

The secondary battery negative electrode of the present disclosure may have an active material layer, and may optionally have a current collector in contact with the active material layer. FIG. 1 schematically illustrates a configuration of a secondary battery 100 according to an embodiment. As illustrated in FIG. 1, the negative electrode 30 of the secondary battery 100 may include an active material layer 31 and a current collector 32 in contact with the active material layer 31.

### 1.2.1 Current Collector

As the current collector, any of the common current collectors can be employed. The current collector may be a foil, a plate, a mesh, a punching metal, a foam, or the like. The current collector may be a metal foil or a metal mesh, or may be a carbon sheet. In particular, a metal foil is excellent in handleability and the like. The current collector may be formed of a plurality of foils or sheets. Examples of the metal constituting the current collector include Cu, Ni, Cr, Au, Pt, Ag, Al, Fe, Ti, Zn, Co, and stainless-steel. In particular, from the viewpoint of ensuring reduction resistance and the like, the current collector may include at least one metal selected from Cu, Ni and stainless steel. The current collector may have some coating layer on the surface thereof for the purpose of adjusting the resistance or the like. The current collector may be formed by plating or depositing the metal on a metal foil or a substrate. When the current collector is made of a plurality of metal foils, some layer may be provided between the plurality of metal foils. The thickness of the current collector is not particularly limited. For example, the thickness may be 0.1 μm or more or 1 μm or more, or may be 1 mm or less or 100 μm or less.

### 1.2.2 Other Configurations

The secondary battery negative electrode of the present disclosure may have a general configuration as a negative electrode of a secondary battery in addition to the active material layer and the current collector described above. For example, the positive electrode 10 includes a tab and a terminal.

### 1.3 Supplement

The secondary battery negative electrode of the present disclosure is preferably used, for example, as a negative electrode of a lithium ion secondary battery. During charging and discharging of a lithium ion secondary battery, silicon as an active material absorbs lithium ions and expands greatly, and also releases lithium ions and shrinks greatly. That is, in a conventional lithium ion secondary battery, expansion and contraction of silicon as an active material are large during charging and discharging, a thickness change of a negative electrode is large, and a restraining pressure is easily greatly changed. In particular, in a lithium ion secondary battery including a sulfide solid electrolyte, the restraining pressure tends to be excessively large. On the other hand, by adopting the secondary battery negative electrode of the present disclosure in the lithium ion secondary battery, a change in thickness of the negative electrode during charging and discharging can be suppressed to be small, and a change in the restraining pressure can be reduced.

### 1.4 Effect

As described above, in the secondary battery negative electrode of the present disclosure, the active material layer includes composite particles of porous silicon particles and a binder, and the porosity of the active material layer is as large as more than 15%. The secondary battery negative electrode of the present disclosure has such an active material layer having a large porosity, and thus the thickness change during charging and discharging is small. Further, in the secondary battery negative electrode of the present disclosure, the porous silicon particles are combined with the binder in the active material layer, and the composite particles and the sulfide solid electrolyte are combined with each other, whereby a conductive path and an ion conduction path are secured, and the resistance of the negative electrode tends to be small. In particular, when the composite particles have the above-described predetermined aspect ratio or when the composite particles contain porous carbon as a binder, the resistance of the negative electrode tends to be further reduced.

### 2. Manufacturing Method of Secondary Battery Negative Electrode

The secondary battery negative electrode of the present disclosure can be manufactured, for example, as follows. That is, a manufacturing method of a secondary battery negative electrode of the present disclosure includes:

Obtaining LiSi precursors comprising Li and Si;
Removing Li from LiSi precursors to obtain porous silicon-particles;
Obtaining composite particles comprising a plurality of said porous silicon particles and a binder,
Obtaining an active material mixture comprising a sulfide solid electrolyte and the composite particles; and
Pressing the active material mixture to obtain an active material layer having a porosity of more than 15%,

### Include.

### Obtaining 2.1LiSi Precursors

LiSi precursors contain Li and Si as constituent elements. LiSi precursors may be, for example, alloys of Li and Si. LiSi precursors may be any precursors that can be made porous by forming voids by removing Li. LiSi precursors may have a crystalline phase of Si (diamond-type). The crystalline phase of Si has typical peaks at 20=28.4°, 47.3°, 56.1°, 69.2°, and 76.4° in XRD measurements using CuKα radiation. These peak positions may be in the range of ±0.5° or in the range of ±0.3°, respectively. LiSi precursors may have a crystalline phase of Si (diamond-type) as the main phase. The “main phase” refers to the crystalline phase to which the peak having the greatest intensity belongs in XRD charts. LiSi precursors may have a crystalline phase of Li₂₂Si₅ or a crystalline phase of Li₁₅Si₄. The crystalline phase of Li₂₂Si₅ has typical peaks at positions of 20=24.8° and 40.8° in XRD measurement using CuKα radiation, and the crystalline phase of Li₁₅Si₄ has typical peaks at positions of 2θ=20.3°, 26.2°, 39.4°, 41.2°, and 42.9° in XRD measurement using CuKα radiation. These peak positions may be in the range of ±0.5° or in the range of ±0.3°, respectively.

LiSi precursors are not particularly limited. LiSi precursors may contain only Li and Si elements, and may contain other elements in addition to Li and Si elements. The ratio of the sum of Li element and Si element to all the elements included in LiSi precursors may be, for example, not less than 50 mol %, not less than 70 mol %, or not less than 90 mol %. In LiSi precursors, the ratio of Li element to the sum of Li element and Si element may be, for example, 30 mol % or more, 50 mol % or more, or 80 mol % or more, and may be 95 mol % or less, or 90 mol % or less.

LiSi precursors may be obtained by mixing a raw material containing a Li element and a raw material containing a Si element. For example, in the disclosed manufacturing method, Si grains and Li may be mixed to obtain LiSi precursors. Examples of the mixing method include a method in which Si particles and Li metal are mixed with each other using an agate mortar, a method in which Si particles and Li metal are mixed with each other using a mechanical milling method, and the like. The temperature and pressure at the time of mixing are not particularly limited. Heating or cooling may or may not be performed at the time of mixing, or pressurization or depressurization may or may not be performed. The atmosphere at the time of mixing is not particularly limited, and may be, for example, an inert gas atmosphere such as an Ar atmosphere. The shape and size of Si particles and Li metal to be mixed are not particularly limited, and may be appropriately selected in accordance with the shape, size, and the like of the desired porous silicon particles.

### 2.2 Obtaining Porous Silicon Particles

In the manufacturing method of the present disclosure, Li may be removed from LiSi precursors to obtain porous silicon-particles. In the disclosed manufacturing method, it is not necessary to remove all of Li from LiSi precursors, and Li elements may partially remain in the porous silicon grains. Methods for removing Li from LiSi precursors are not particularly limited. For example, Li may be extracted from LiSi precursors. Li extraction solvents may be used to extract Li. For example, by contacting LiSi precursor with a Li extraction solvent, Li extraction solvent reacts with Li extraction solvent, and Li is extracted from LiSi precursor into Li extraction solvent. The form in which LiSi precursor is contacted with Li extraction solvent is not particularly limited, and LiSi precursor may be immersed in Li extraction solvent, LiSi precursor may be sprayed with Li extraction solvent, LiSi precursor may be mixed with Li extraction solvent, or LiSi precursor may be dispersed in a dispersion medium to form a dispersion liquid, and the dispersion liquid and Li extraction solvent may be mixed.

As Li extracting solvents, for example, alcohols such as methanol, ethanol, and propanol can be used. Li extracting solvent may comprise a side solvent with an alcoholic. Examples of the secondary solvent include acids described later. Depending on the type of Li extraction solvents, Li extraction rate varies, and the size of the pores formed after Li extraction varies. For example, when comparing the use of methanol as Li extracting solvent, the use of ethanol, and the use of propanol, Li extracting rate is the fastest when methanol is used, followed by the use of ethanol, followed by 1-propanol, followed by isopropanol. In addition, the pore size after Li extraction is most likely to be large when methanol is used, and then ethanol, then 1-propanol, and then isopropanol are used. The type of Li extraction solvents and the extraction times may be selected depending on the desired pore size. The voids formed in the active material after Li is extracted have various pore diameters. Here, by adjusting the pore diameter of the porous silicon particles after Li is extracted, the pores are less likely to collapse even when the porous silicon particles are pressurized (for example, when the negative electrode is pressed at the time of manufacturing the batteries). For example, as described above, by increasing the pore size of the porous silicon particles in the diametrical 55 nm or less, the pores are less likely to collapse, and the expansion and contraction of the active material during charging and discharging is more easily suppressed.

The disclosed manufacturing method may include dispersing a LiSi precursor in a dispersion medium to obtain a dispersion liquid, and mixing the dispersion liquid and a Li extracting solvent to extract Li from LiSi precursor to form a void. In this case, the pore size of the porous silicon particles after Li is extracted can be more appropriately adjusted. Examples of the dispersing medium include one or more solvents selected from saturated hydrocarbons such as n-heptane, n-octane, n-decane, 2-ethylhexane, and cyclohexane, unsaturated hydrocarbons such as hexene and heptene, unsaturated hydrocarbons such as heptene and heptene, and ethers such as 1,3,5-trimethylbenzene, toluene, xylene, ethylbenzene, propylbenzene, cumene, 1,2,4-trimethylbenzene, and 1,2,3-trimethylbenzene, and ethers such as n-butyl ether, n-hexyl ether, isoamyl ether, diphenyl ether, methyl phenyl ether, and cyclopentyl methyl ether. Among these, at least one selected from n-butyl ether, 1,3,5-trimethylbenzene and n-heptane is preferred, and 1,3,5-trimethylbenzene is particularly preferred. The amount of water in the dispersion medium is preferably small. This is because water reacts with LiSi precursors. Water content in the dispersion medium may be, for example, 100 ppm below, 50 ppm below, 30 ppm below, or 10 ppm below. The ratio (solid content ratio) of LiSi precursor in the dispersion liquid is not particularly limited, and it is sufficient that the ratio is such that LiSi precursor can be dispersed in the dispersion medium. The dispersion is obtained, for example, by mixing LiSi precursors and a dispersion medium. The mixing means in this case is not particularly limited.

Li is extracted from LiSi precursors using Li extracting solvents. When Li is extracted, it may or may not be heated or cooled, or may or may not be pressurized or depressurized. There is no particular limitation on the atmosphere and Li extraction times at the time of Li extraction. In addition, there is no particular limitation on the ratio of Li extracting solvents to LiSi precursors at the time of Li extracting. Temperatures, pressures, times, proportions, and the like may be adjusted to extract the required amounts of Li from LiSi precursors.

Li may be removed from LiSi precursors in one step or in two or more steps. For example, the porous silicon particles may be obtained in one stage only by reacting LiSi precursors with Li extracting solvent, or the porous silicon particles may be obtained through two or more stages of extracting treatment by extracting Li using Li extracting solvent again after forming voids using Li extracting solvent, or by extracting Li using an acid. The use of Li extractants followed by the use of acids allows for more adequate extraction of Li from LiSi precursors. Examples of the acid include one or more of acetic acid, formic acid, propionic acid, and oxalic acid. Acetic acid is particularly preferred. There are no particular limitations on the temperature, pressure, time, volume ratio, and the like at the time of extracting Li using the acid.

The porous silicon-particles after Li extraction may optionally be washed. Accordingly, impurities contained in the porous silicon particles can be reduced. When the concentration of LiSi precursor in the sum of LiSi precursor and the Li extracting solvent is high, the production efficiency is high, but the production amount of impurities is likely to increase. For example, when the concentration of LiSi precursors is higher than or equal to the concentration of 1 L in Li extracting solvent by 3.3 g, the active material after Li extracting is cleaned, thereby achieving both an improvement in production efficiency and a reduction in impurities. The washing may be, for example, acid washing in which the acid is brought into contact with the porous silicon particles. The extracting of Li element by the acid may also serve as acid cleaning of the porous silicon grains.

### 2.3 Obtaining Composite Particles

In the manufacturing method of the present disclosure, the composite particles are obtained by the plurality of porous silicon particles and the binder obtained as described above. The composite particles can be obtained, for example, by mixing porous silicon particles and a binder. The mixing ratio of the porous silicon particles and the binder is not particularly limited, and may be appropriately determined according to the composition of the target composite particles. The mixing may be carried out dry or wet. For example, the porous silicon particles and the binder may be dispersed or dissolved in a dispersion medium to obtain a slurry, and the slurry may be dried to form a composite of the porous silicon particles and the binder. The type of the dispersion medium is not particularly limited, and for example, dimethyl carbonate or the like may be employed. Drying of the slurry may be performed by known drying means. Examples thereof include spray drying and drying by rolling. Specifically, it may be dried using a spray dryer. On the other hand, the formation of the composite particles by the dry method can be performed, for example, by applying compression or physical impact to the porous silicon particles and the binder.

As described above, in the secondary battery negative electrode of the present disclosure, the composite particles may contain porous carbon as a binder. This makes it possible to further reduce the resistance of the negative electrode. In view of this, the manufacturing method of the present disclosure may include mixing a plurality of porous silicon particles and an organic component to obtain an intermediate composite, and carbonizing the organic component of the intermediate composite to obtain a composite particle including a plurality of porous silicon particles and porous carbon as a binder. The organic component may be any component capable of becoming porous carbon by carbonization. For example, when the organic component carbonizes, some elements are removed from the organic component to form a void. Further, in the intermediate composite, it is preferable that the plurality of porous silicon particles are bonded to each other via an organic component. That is, the organic component is preferably one that becomes porous carbon by carbonization and has a function of binding porous silicon particles to each other. Specific examples of such organic components include butadiene rubber (BR), butylene rubber (IIR), acrylate butadiene rubber (ABR), styrene butadiene rubber (SBR), polyvinylidene fluoride (PVdF), polytetrafluoroethylene (PTFE), carboxymethylcellulose (CMC), polyacrylates, and polyacrylates. For example, when a binding fluorine-based organic compound such as PVdF or PTFE is used as the organic component, when the fluorine-based organic compound is carbonized, H or F becomes hydrofluoric acid or the like and is volatilized and removed to form a void, so that a porous carbon having small pores is obtained.

### 2.4 to Obtain an Active Material Mixture

In the manufacturing method of the present disclosure, the active material mixture is obtained by the composite particles obtained as described above and the sulfide solid electrolyte. For example, the composite particles are mixed together with the sulfide solid electrolyte to obtain an active material mixture. The active material mixture may contain a component constituting the active material layer, and as described above, may contain an optional component such as a conductive agent in addition to the composite particles and the sulfide solid electrolyte. The active material mixture is obtained by mixing these components by a known method. Mixing may be carried out dry or wet. That is, the active material mixture may be made of only a solid such as a composite particle and a sulfide solid electrolyte, or may be in a state in which a solid such as a composite particle and a sulfide solid electrolyte is dispersed in a dispersion to form a slurry. The mixing conditions of the active material mixture are not particularly limited.

### 2.5 Obtaining an Active Material Layer

When an active material mixture is obtained, when a slurry containing an active material mixture is obtained by wet mixing, for example, the slurry may be applied to a surface of a current collector or an electrolyte layer to be described later and dried, and the active material mixture may be laminated on the surface of the current collector or the electrolyte layer, and the active material mixture may be pressed to form an active material layer. Alternatively, the active material layer may be formed by dry molding (for example, powder molding) the active material mixture. In any case, in the manufacturing method of the present disclosure, the active material mixture obtained as described above is pressed to obtain an active material layer.

Here, the porosity in the active material layer may change depending on the magnitude of the pressure applied to the active material mixture. Further, even if the pressure applied to the active material mixture is the same, the porosity of the active material layer may change depending on the composition of the active material mixture. For example, the fluidity of the active material mixture is different between the case where the active material mixture contains a liquid and the case where the active material mixture contains only a solid. The fluidity of the active material mixture also varies depending on the size and shape of the particles contained in the active material mixture. Such a difference in fluidity may change the porosity of the active material after pressing. In the manufacturing method of the present disclosure, the magnitude of the pressure applied to the active material mixture may be adjusted according to the form and composition of the active material mixture so that the porosity of the active material layer is more than 15%. The porosity of the active material layer after pressing may be, for example, 50% or less, 45% or less, 40% or less, 35% or less, 30% or less, 25% or less, or 20% or less. The means for pressing the active material mixture is not particularly limited. For example, various press means such as a CIP, HIP, a roll press, a uniaxial press, and a mold press can be employed.

As described above, in the secondary battery negative electrode of the present disclosure, when the composite particles are pressed to such an extent that the composite particles have a predetermined aspect ratio, the contact resistance in the composite particles, the contact resistance between the composite particles, and the contact resistance between the composite particles and other materials can be reduced, and the resistance of the entire negative electrode can be reduced. From this viewpoint, the manufacturing method of the present disclosure may include deforming the composite particles by pressing the active material mixture, when observing the cross section of the active material layer after pressing, half or more of the plurality of composite particles extracted by the following extraction method may have an aspect ratio of 2.5 or more, i.e., the composite particles are the desired aspect ratio, the magnitude of the pressure applied to the active material mixture, etc. may be adjusted.

Extraction method: The cross section of the active material layer is observed, the composite particles included in the cross section are extracted in descending order of cross-sectional area, and extraction is terminated when the total area of the extracted composite particles exceeds 80% of the total area of all the composite particles included in the cross section.

### 3. Secondary Battery

A secondary battery of the present disclosure includes the above-described secondary battery negative electrode of the present disclosure. FIG. 1 shows a configuration of a secondary battery 100 according to an embodiment. As illustrated in FIG. 1, the secondary battery 100 includes a positive electrode 10, an electrolyte layer 20, and a negative electrode 30, and the negative electrode 30 is the secondary battery negative electrode of the present disclosure.

### 3.1 Positive Electrode

In the secondary battery 100, the positive electrode 10 may have, for example, the following configuration. As illustrated in FIG. 1, the positive electrode 10 according to an embodiment may include a positive electrode active material layer 11 and a positive electrode current collector 12.

### 3.1.1 Positive Electrode Active Material Layer

The positive electrode active material layer 11 includes a positive electrode active material, and may further optionally include an electrolyte, a conductive auxiliary agent, a binder, and the like. In addition, the positive electrode active material layer 11 may contain various additives. The contents of each of the positive electrode active material, the electrolyte, the conductive aid, the binder, and the like in the positive electrode active material layer 11 may be appropriately determined in accordance with the target battery performance. For example, the content of the positive electrode active material may be 40% by mass or more, 50% by mass or more, or 60% by mass or more, and may be less than 100% by mass or 90% by mass or less, assuming that the entire positive electrode active material layer 11 (the entire solid content) is 100% by mass. The shape of the positive electrode active material layer 11 is not particularly limited, and may be, for example, a sheet shape having a substantially flat surface. Thickness of the positive electrode active material layer 11 is not particularly limited, for example, 0.1 micrometers or more, 1 micrometers or more, may be 10 micrometers or more or 30 micrometers or more, 2 mm or less, 1 mm or less, 500 micrometers or less or 100 micrometers or less.

As the positive electrode active material, a material known as a positive electrode active material of a secondary battery may be used. Among the known active materials, a material having a potential (charge-discharge potential) at which a predetermined ion is occluded and released is more noble than that of a negative electrode active material to be described later can be used as the positive electrode active material. For example, in the case of configuring a lithium ion secondary battery, various lithium-containing composite oxides such as lithium cobaltate, lithium nickelate, lithium manganate, lithium manganese nickel cobaltate, and a spinel-based lithium compound may be used as the positive electrode active material, or a sulfur-based active material such as elemental sulfur or a sulfur compound may be used. Only one positive electrode active material may be used alone, or two or more positive electrode active materials may be used in combination. The positive electrode active material may be, for example, in a particulate form, and the size thereof is not particularly limited. The particles of the positive electrode active material may be solid particles, hollow particles, or particles having voids. The particles of the positive electrode active material may be primary particles or secondary particles in which a plurality of primary particles are aggregated. The mean particle size of the particles of the positive electrode active material may be more than 1 nm, more than 5 nm, or more than 10 nm, or may be less than 500 m, less than 100 m, less than 50 m, or less than 30 m.

The surface of the positive electrode active material may be covered with a protective layer containing an ion conductive oxide. That is, the positive electrode active material layer 11 may include a composite including the positive electrode active material described above and a protective layer provided on the surface thereof. As a result, a reaction between the positive electrode active material and a sulfide (for example, a sulfide solid electrolyte, or the like) is easily suppressed. As an ion conductive oxide which covers and protects the surface of a positive electrode active material when a rechargeable battery is a rechargeable lithium-ion battery, for example, Li₃BO₃, LiBO₂, Li₂CO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, Li₂WO₄. The coverage (area ratio) of the protective layer may be, for example, 70% or more, 80% or more, or 90% or more. The thickness of the protective layer may be, for example, 0.1 nm or more or 1 nm or more, or may be 100 nm or less or 20 nm or less.

The electrolyte that may be included in the positive electrode active material layer 11 may be a solid electrolyte, a liquid electrolyte, or a combination thereof. The electrolyte may be the same as or different from that of the secondary battery negative electrode of the present disclosure. In particular, when the positive electrode contains a sulfide solid electrolyte, a higher effect can be expected. The conductive auxiliary agent and the binder that can be included in the positive electrode active material layer 11 may be the same as or different from those in the secondary battery negative electrode of the present disclosure.

### 3.1.2 Positive Electrode Current Collector

As shown in FIG. 1, the positive electrode 10 may include the positive electrode current collector 12 in contact with the positive electrode active material layer 11. As the positive electrode current collector 12, any general positive electrode current collector of the battery can be adopted. The positive electrode current collector may be a foil, a plate, a mesh, a punching metal, a foam, or the like. The positive electrode current collector may be a metal foil or a metal mesh. In particular, a metal foil is excellent in handleability and the like. The positive electrode current collector may be formed of a plurality of foils or sheets. Examples of the positive electrode current collector include Cu, Ni, Cr, Au, Pt, Ag, Al, Fe, Ti, Zn, Co, and stainless-steel. In particular, from the viewpoint of ensuring oxidation resistance or the like, the current collector may contain Al. The positive electrode current collector may have some coating layer on the surface thereof for the purpose of adjusting resistance or the like. The positive electrode current collector may be formed by plating or depositing the metal on a metal foil or a base material. In the case where the positive electrode current collector is made of a plurality of metal foils, some layer may be provided between the plurality of metal foils. The thickness of the positive electrode current collector is not particularly limited. For example, the thickness may be 0.1 μm or more or 1 μm or more, or may be 1 mm or less or 100 μm or less.

In addition to the above configuration, the positive electrode 10 may have a general configuration as a positive electrode of a secondary battery. For example, the positive electrode 10 includes a tab and a terminal. The positive electrode 10 can be manufactured by applying a known method. For example, the positive electrode active material layer 11 can be easily formed by, for example, dry or wet molding of a positive electrode mixture containing the above-described various components. The positive electrode active material layer 11 may be formed together with the positive electrode current collector 12, or may be formed separately from the positive electrode current collector 12.

### 3.2 Electrolyte Layer

The electrolyte layer 20 contains at least an electrolyte. The electrolyte layer 20 may include a solid electrolyte, and may optionally include a binder or the like. The content of the solid electrolyte, the binder, and the like in the electrolyte layer 20 is not particularly limited. Alternatively, the electrolyte layer 20 may include an electrolyte solution, and may further include a separator or the like for holding the electrolyte solution and suppressing contact between the positive electrode active material layer 11 and the negative electrode active material layer 31. The thickness of the electrolyte layer 20 is not particularly limited, and may be, for example, 0.1 μm or more or 1 μm or more, or may be 2 mm or less or 1 mm or less.

The electrolyte included in the electrolyte layer 20 may be appropriately selected from those exemplified as the electrolyte that can be included in the secondary battery negative electrode of the present disclosure. In particular, the electrolyte layer 20 preferably includes a sulfide solid electrolyte. The binder that can be included in the electrolyte layer 20 may be appropriately selected from those exemplified as the binder that can be included in the secondary battery negative electrode of the present disclosure. Electrolytes and binders, respectively, only one may be used alone, or two or more may be used in combination.

When the electrolyte layer 20 contains a liquid component such as an electrolyte solution, the liquid component may be held in a gap of the solid electrolyte or may be held by a separator. The separator may be a separator commonly used in secondary batteries, and examples thereof include a separator made of a resin such as polyethylene (PE), polypropylene (PP), polyester, and polyamide. The separator may have a single-layer structure or a multi-layer structure. Examples of the separator having a multi-layer structure include a separator having a two-layer structure of PE-PP, a separator having a three-layer structure of PP-PE-PP or PE-PP-PE, and the like. The separator may be made of a non-woven fabric such as a cellulose non-woven fabric, a resin non-woven fabric, or a glass fiber non-woven fabric.

### 3.3 Negative Electrode

The negative electrode 30 is the secondary battery negative electrode of the present disclosure described above. Details of the secondary battery negative electrode of the present disclosure have been described above.

### 3.4 Supplement

The secondary battery may be an all-solid battery substantially free of a liquid electrolyte, or may include a liquid component together with a sulfide solid electrolyte. The secondary battery may have at least the above-described configurations, and may have other members in addition thereto. The members described below are examples of other members that the secondary battery may have.

In the secondary battery, each of the above-described configurations may be accommodated in an exterior body. More specifically, a portion excluding a tab, a terminal, or the like for extracting electric power from the secondary battery to the outside may be accommodated in the exterior body. As the exterior body, any known exterior body of the battery can be adopted. For example, a laminate film may be used as the exterior body. Further, a plurality of secondary batteries may be electrically connected to each other, and may be arbitrarily stacked to form a battery pack. In this case, the assembled battery may be housed inside a known battery case. As the shape of the secondary battery, for example, coin-type, laminate-type, cylindrical, and square-type, and the like.

In the secondary battery, the components described above may be sealed with resin. For example, at least a side surface (a surface along the lamination direction of each layer) of the positive electrode, the electrolyte layer, and the negative electrode may be sealed with resin. As a result, it is easy to suppress the mixing of moisture and the like into the inside of each layer. As the sealing resin, a known curable resin or thermoplastic resin can be employed.

The secondary battery may or may not have a restraining member for restraining each of the above-described components in the thickness direction (the direction along the stacking direction of each layer). When the restraining pressure is applied by the restraining member, the internal resistance of the battery is easily reduced. The restraining pressure by the restraining member is not particularly limited.

The secondary battery can be manufactured by applying a known method. For example, can be manufactured as follows. However, the manufacturing method the secondary battery is not limited to the following method. For example, the secondary battery may be manufactured through dry molding such as green compact molding.
(1) A negative electrode mixture constituting the negative electrode active material layer is prepared. The negative electrode mixture may be in the form of a slurry dispersed in a solvent. The solvent used in this case is not particularly limited, and various organic solvents can be used. The slurry is applied to the surface of the negative electrode current collector or the electrolyte layer using a doctor blade or the like, and then dried to form a negative electrode active material layer.
(2) A positive electrode mixture constituting the positive electrode active material layer is prepared. The positive electrode mixture may be in the form of a slurry dispersed in a solvent. The solvent used in this case is not particularly limited, and various organic solvents can be used. The slurry is applied to the surface of the positive electrode current collector or the electrolyte layer using a doctor blade or the like, and then dried to form a positive electrode active material layer.
(3) An electrolyte layer is sandwiched between the negative electrode active material layer and the positive electrode active material layer, and a laminate including a negative electrode current collector, a negative electrode active material layer, an electrolyte layer, a positive electrode active material layer, and a positive electrode current collector is obtained in this order. Other members such as terminals are attached to the laminated body as needed.
(4) The laminate is housed in a battery case and sealed to obtain a secondary battery. When a battery including an electrolyte solution is obtained, the electrolyte solution may be sealed together with the laminate.

### 3.5 Effect

As described above, in the secondary battery of the present disclosure, since the change in the thickness of the negative electrode during charging and discharging is small, for example, the change in the constraining pressure due to the change in the thickness of the negative electrode is difficult to increase. In addition, since the resistance of the negative electrode is small, the negative electrode is likely to have excellent charge-discharge performance. In particular, when the composite particles in the negative electrode have the above-described predetermined aspect ratio or when the composite particles contain porous carbon as a binder, the resistance of the negative electrode is further reduced, and the composite particles tend to have better performance.

Although an embodiment of the secondary battery negative electrode and the like of the present disclosure has been described above, the secondary battery negative electrode and the like of the present disclosure can be variously modified in addition to the above embodiment without departing from the gist thereof.

Hereinafter, the technique of the present disclosure will be described in more detail with reference to examples. However, the technique of the present disclosure is not limited to the following examples. In the following examples, a case in which an all-solid-state battery that does not contain a liquid component is configured using the secondary battery negative electrode of the present disclosure is exemplified, but it is considered that the presence of the liquid does not substantially affect the problem solving mechanism and effects of the technology of the present disclosure. That is, the technology of the present disclosure is also applicable to a secondary battery including a liquid component.

### 1. Example 1

In the following procedure, porous silicon particles were prepared, composite particles were prepared using the porous silicon particles and a binder, a negative electrode active material mixture was prepared using the composite particles and a sulfide solid electrolyte, a negative electrode was prepared using the negative electrode active material mixture, and an all-solid battery was prepared using the negative electrode.

### Fabrication of 1.1 Nanoporous Si

Si grains (particle size 0.5 m, manufactured by High-purity Chemical Co.) 0.65 g and Li metallic (made of Honjo Metals) 0.60 g were mixed in an agate mortar in an Ar atmosphere to obtain LiSi precursors. In a glass reactor in the Ar atmosphere, LiSi precursor 1.0 g and the dispersing medium (1,3,5-trimethylbenzene, Nacalai Tesque) 125 ml were mixed using an ultrasonic homogenizer (manufactured by UH-50, SMT). After mixing, the obtained LiSi precursor dispersion was cooled to 0° C., and an ethanol (Nacalai Tesque) 125 ml as a Li extractant was added dropwise, and the mixture was allowed to react for 120 minutes. After the reaction, acetic acid (manufactured by Nacalai Tesque) 50 ml was added dropwise, and the reaction was allowed to proceed for 60 minutes. After the reaction, the liquid and the solid reactant were separated by suction filtration. The resulting solid-state reactant was vacuum-dried at 120° C. for 2 hours to recover porous silicon particles containing a plurality of pores having a diametric 55 nm or less (nanoporous Si).

### 1.2 Preparation of Composite Particles

The above nanoporous Si (primary particles) and a PVDF-HFP binder (manufactured by Kureha Co., Ltd.) were dispersed in dimethyl carbonate (manufactured by Nacalai Tesque Co., Ltd.) so as to obtain a ratio of primary particles:binder=100:13.3 (mass ratio), partially dissolved, to obtain a slurry. The slurry was sprayed into a 140° C. nitrogen-gas-atmosphere spray dryer and dried to obtain a nanoporous Si and binder-containing composites.

### 1.3 Synthesis of Sulfide Solid Electrolytes

Li₂S (manufactured by Furuuchi Chemical Co.) 0.550 g, P₂S₅ (manufactured by Aldrich) o.887 g, LiI (manufactured by Nippoh Chemicals Co., Ltd) 0.285 g and LiBr (manufactured by Nikho Chemical Co., Ltd.) 0.277 g were mixed for 5 minutes in an agate mortar. To the obtained mixtures, n-heptane (dehydrated-grade, manufactured by Kanto Chemical Co., Ltd.) was added 4 g and subjected to mechanical milling using a planetary ball mill for 40 hours to obtain a sulfide solid-state electrolyte.

### 1.4 Preparation of Negative Electrode Mixture

The composite-particle 1.0 g, the conductive auxiliary agent (VGCF, manufactured by Showa Denko Co., Ltd.) 0.04 g, the solid-state electrolyte 0.776 g, the binder (PVdF, manufactured by Kureha) 0.02 g, and the butyl butyrate (manufactured by Kishida Chemical Co., Ltd.) 1.7 g were mixed using an ultrasonic homogenizer (manufactured by UH-50, SMT Co., Ltd.) to obtain a negative electrode mixture.

### 1.5 Preparation of Positive Electrode Composite Material

LiNi_{1/3}Co_{1/3}Mn_{1/3}O₂ (manufactured by Nichia Chemical Industry Co., Ltd.) was surface-treated using LiNbO₃ to obtain a positive electrode active material. The positive electrode active material 1.5 g, a conductive auxiliary agent (VGCF, manufactured by Showa Denko Co., Ltd.) 0.023 g, the solid-state electrolyte 0.239 g, a binder (PVdF, manufactured by Kureha) 0.011 g, and a butyl butyrate (manufactured by Kishida Chemical Co., Ltd.) 0.8 g were mixed using an ultrasonic homogenizer (manufactured by UH-50, SMT Co., Ltd.) to obtain a positive electrode mixture.

### 1.6 Preparation of Evaluation Battery

The solid electrolyte 0.065 g was placed in a ceramic mold of 1 cm², and pressed with 1 ton/cm² to prepare a separate layer (solid electrolyte layer). The positive electrode mixture 0.018 g was placed on one side thereof, and pressed with 1 ton/cm² to prepare positive electrode active material layers. The negative electrode active material layer was prepared by placing the negative electrode mixture 0.0054 g on the opposite side of the positive electrode active material layer and pressing with 4 ton/cm². An evaluation battery was prepared by laminating an aluminum foil as a positive electrode current collector to the positive electrode active material layer and a copper foil as a negative electrode current collector to the negative electrode active material layer.

### 1.7 Calculation of Porosity and Filling Rate in Negative Electrode Active Material Layer

The porosity of the negative electrode active material layer was defined as A, the sum of the volumes obtained by dividing the weights of the respective materials constituting the negative electrode active material layer by the true densities of the respective materials was defined as x, the volume obtained from the dimension (area×thickness) of the negative electrode active material layer was defined as y, and the porosity A of the negative electrode active material layer was calculated by A (%)=(1−x/y)×100). The packing ratio (100−A (%) in the negative electrode active material layer was calculated from the porosity A.

### 1.8 Measurement of Constrained Pressure Increase

Regarding the cell for evaluating, 0.245 mA was 4.55V and CC/CV discharged at 0.245 mA to 3.0V after CC/CV charge. During the initial charge, the restraint pressure of the cell was monitored and the restraint pressure at 4.55V was measured.

### 1.9 Resistance Measurement

0.3 mA was charged to 4.35V for CC/CV and then discharged at 0.3 mA to 2.5V for CC/CV. This was repeated 5 times. Thereafter, the voltage was adjusted to 3.7V, and the resistivity was determined from the voltage drop when the current of 10 mA was passed for 5 seconds.

### 2. Example 2

Composite particles were prepared in the same manner as in Example 1, except that the nanoporous Si (primary particles) and PVDF-HFP binder were dispersed and dissolved in dimethyl carbonate (Nacalai Tesque) so as to have a ratio (mass ratio) of primary particles:binder=100:26.7 to obtain a slurry. Using the prepared composite particles, an evaluation battery was prepared in the same manner as in Example 1, and the porosity and the filling rate in the negative electrode active material layer were calculated, the amount of increase in the constrained pressure was measured, and the resistance was measured.

### 3. Example 3

The nanoporous Si (primary particles) and PVDF-HFP binder were dispersed in dimethyl carbonate (Nacalai Tesque) so as to have a ratio (mass ratio) of primary particles:binder=100:40, dissolved, and a slurry was obtained, the slurry was sprayed into a spray dryer in a nitrogen gas atmosphere at 140° C., dried, and the dried particles were subjected to a heat treatment in a nitrogen atmosphere at 550° C. for 1 hour to carbonize PVDF-HFP binder to obtain porous carbon. This resulted in a composite-particle comprising a nanoporous Si and porous carbon as a binder. The weight ratio of the porous carbon as the binder after the carbonization treatment was a ratio of nanoporous Si:porous carbon=100:12. Using the composite particles, an evaluation battery was prepared in the same manner as in Example 1, and the porosity and the filling rate in the negative electrode active material layer were calculated, the amount of increase in the constrained pressure was measured, and the resistance was measured.

### 4. Comparison Example 1

Except that Si grains (particle size 0.5 m, manufactured by High Purity Chemical Co., Ltd.) were used instead of the composite grains, in the same manner as in Example 1, to prepare an evaluation cell, the calculation of the porosity and the filling rate in the negative electrode active material layer, the measurement of the constrained pressure increasing amount, and the resistance measurement was performed.

### 5. Comparative Example 2

Composite particles were prepared in the same manner as in Example 1, except that Si particles of Comparative Example 1 and PVDF-HFP binder were dispersed and dissolved in dimethyl carbonate (Nacalai Tesque) so as to have a ratio (mass ratio) of primary particles:binder=100:13.3, and a slurry was obtained. Using the prepared composite particles, an evaluation battery was prepared in the same manner as in Example 1, and the porosity and the filling rate in the negative electrode active material layer were calculated, the amount of increase in the constrained pressure was measured, and the resistance was measured.

### 6. Comparative Example 3

Except for using the above-described nanoporous Si in place of the composite particles, an evaluation cell was prepared in the same manner as in Example 1, and the porosity and the filling rate in the negative electrode active material layer were calculated, the amount of restrained pressure increased was measured, and the resistivity was measured.

### 7. Comparative Example 4

Composite particles were prepared in the same manner as in Example 1, except that the nanoporous Si (primary particles) and PVDF-HFP binder were dispersed and dissolved in dimethyl carbonate (Nacalai Tesque) so as to have a ratio (mass ratio) of primary particles:binder=100:40, and a slurry was obtained. Using the prepared composite particles, an evaluation battery was prepared in the same manner as in Example 1, and the porosity and the filling rate in the negative electrode active material layer were calculated, the amount of increase in the constrained pressure was measured, and the resistance was measured.

### 8. Comparative Example 5

Composite particles were prepared in the same manner as in Example 1, except that the nanoporous Si (primary particles) and PVDF-HFP binder were dispersed and dissolved in dimethyl carbonate (Nacalai Tesque) so as to have a ratio (mass ratio) of primary particles:binder=100:100 to obtain a slurry. Using the prepared composite particles, an evaluation battery was prepared in the same manner as in Example 1, and the porosity and the filling rate in the negative electrode active material layer were calculated, the amount of increase in the constrained pressure was measured, and the resistance was measured.

### 9. Comparative Example 6

Composite particles were prepared in the same manner as in Example 1, except that the nanoporous Si (primary particles) and PVDF-HFP binder were dispersed and dissolved in dimethyl carbonate (Nacalai Tesque) so as to have a ratio (mass ratio) of primary particles:binder=100:200 to obtain a slurry. Using the prepared composite particles, an evaluation battery was prepared in the same manner as in Example 1, and the porosity and the filling rate in the negative electrode active material layer were calculated, the amount of increase in the constrained pressure was measured, and the resistance was measured.

### 10. Comparative Example 7

Composite particles were prepared in the same manner as in Example 1, except that the nanoporous Si (primary particles) and PVDF-HFP binder were dispersed and dissolved in dimethyl carbonate (Nacalai Tesque) so as to have a ratio (mass ratio) of primary particles:binder=100:300 to obtain a slurry. Using the prepared composite particles, an evaluation battery was prepared in the same manner as in Example 1, and the porosity and the filling rate in the negative electrode active material layer were calculated, the amount of increase in the constrained pressure was measured, and the resistance was measured.

### 11. Porosity and Filling Rate, Constrained Pressure Increase Amount, and Resistance Value

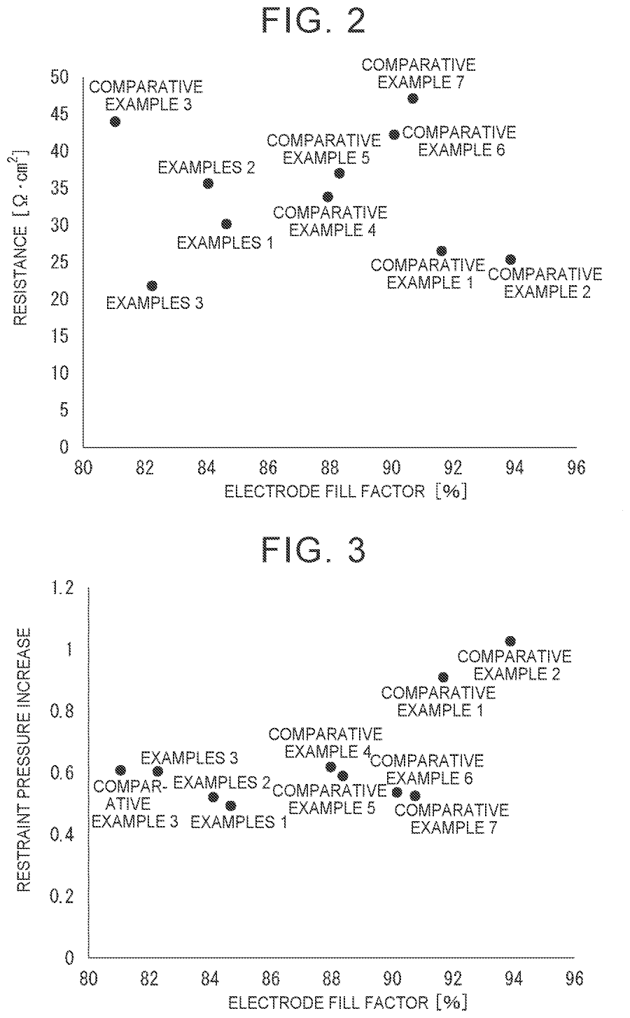

Table 1 below shows the porosity and filling rate, the restraining pressure increase amount, and the resistance value of each of the batteries of Examples 1 to 3 and Comparative Examples 1 to 7. In Table 1 below, the amount of increase in the restraining pressure in the batteries according to Comparative Example 2 was set to 1.00, and the amounts of increase in the restraining pressure in the batteries according to Examples 1 to 3 and Comparative Examples 1 and 3 to 7 were relatively evaluated. FIG. 2 shows the relationship between the filling ratio of each of Examples 1 to 3 and Comparative Examples 1 to 7 and the resistance of the battery. Further, FIG. 3 shows the relationship between the filling rate of each of Examples 1 to 3 and Comparative Examples 1 to 7 and the restraint pressure increase amount of the battery.

TABLE 1

| | Form of | | | | | | |
|---|---|---|---|---|---|---|---|
| | negative | | Mean | | | | |
| | electrode | | particle | Filling | | Constraint | Resistance |
| | active | Binder ratio | diameter | rate | Porosity | pressure | value |
| | material | (wt % vs. Si) | (μm) | (%) | (%) | increase (−) | (Ω · cm²) |
| Example 1 | Composites | 13.3 | 2.8 | 84.7 | 15.3 | 0.48 | 30.1 |
| | (nanoporous | | | | | | |
| | Si + | | | | | | |
| | binders) | | | | | | |
| Example 2 | Composites | 26.7 | 3.7 | 84.1 | 15.9 | 0.51 | 35.5 |
| | (nanoporous | | | | | | |
| | Si + | | | | | | |
| | binders) | | | | | | |
| Example 3 | Composites | 12 | 6.2 | 82.3 | 17.7 | 0.59 | 21.7 |
| | (nanoporous | (after | | | | | |
| | Si + | carboniza- | | | | | |
| | binders) | tion) | | | | | |
| Comparative | Primary | 0 | 0.5 | 91.7 | 8.3 | 0.89 | 26.5 |
| Example 1 | grain | | | | | | |
| | (crystalline | | | | | | |
| | Si) | | | | | | |
| Comparative | Composites | 13.3 | 3.9 | 93.9 | 6.1 | 1.00 | 25.2 |
| Example 2 | (crystalline | | | | | | |
| | Si + | | | | | | |
| | binders) | | | | | | |
| Comparative | Primary | 0 | 0.5 | 81.0 | 19.0 | 0.59 | 44.0 |
| Example 3 | particles | | | | | | |
| | (nanoporous | | | | | | |
| | Si) | | | | | | |
| Comparative | Composites | 40 | 4.6 | 88.0 | 12.0 | 0.60 | 33.7 |
| Example 4 | (nanoporous | | | | | | |
| | Si + | | | | | | |
| | binders) | | | | | | |
| Comparative | Composites | 100 | 4.1 | 88.4 | 11.6 | 0.57 | 36.9 |
| Example 5 | (nanoporous | | | | | | |
| | Si + | | | | | | |
| | binders) | | | | | | |
| Comparative | Composites | 200 | 3.8 | 90.1 | 9.9 | 0.52 | 42.2 |
| Example 6 | (nanoporous | | | | | | |
| | Si + | | | | | | |
| | binders) | | | | | | |
| Comparative | Composites | 300 | 5.0 | 90.7 | 9.3 | 0.51 | 47.1 |
| Example 7 | (nanoporous | | | | | | |
| | Si + | | | | | | |
| | binders) | | | | | | |

From the results shown in Table 1, FIG. 2 and FIG. 3, it can be seen that Examples 1 to 3 satisfying both of (1) that the composite particles as the active material contained in the active material layer include a plurality of nanoporous Si (porous silicon particles) and a binder, and (2) that the active material layer has a porosity of more than 15% can significantly reduce the increase in the constrained pressure (that is, the thickness change of the negative electrode is suppressed to be small) and have a low resistivity. When the porosity of the active material layer is more than 15.0%, it is considered that even when the active material expands, the increase in volume due to the expansion of the active material is relaxed by the voids, and the thickness change of the negative electrode is suppressed to be small. In addition, even when the porosity of the active material layers is more than 15.0%, it is considered that the nanoporous Si is composited together with the binder, so that the ionic conductive path and the conductive path are secured and the resistivity is reduced to a certain extent. In particular, Examples 1 and 2 in which the composite particles contain an organic component as a binder can further significantly reduce the increase in the constraining pressure, and Example 3 in which the composite particles contain porous carbon as a binder can further significantly reduce the resistance. On the other hand, in Comparative Examples 1 to 7, which do not satisfy at least one of (1) and (2), it is difficult to achieve both reduction in the amount of increase in the constraining pressure and reduction in the resistance. In Comparative Examples 4 to 7, the amount of silicon functioning as an active material is relatively excessively small due to an excessively large amount of binder contained in the composite particles, and there is a possibility that the volume energy density of the battery is reduced.

### 12. Determination of the Aspect Ratio of Composite Particles

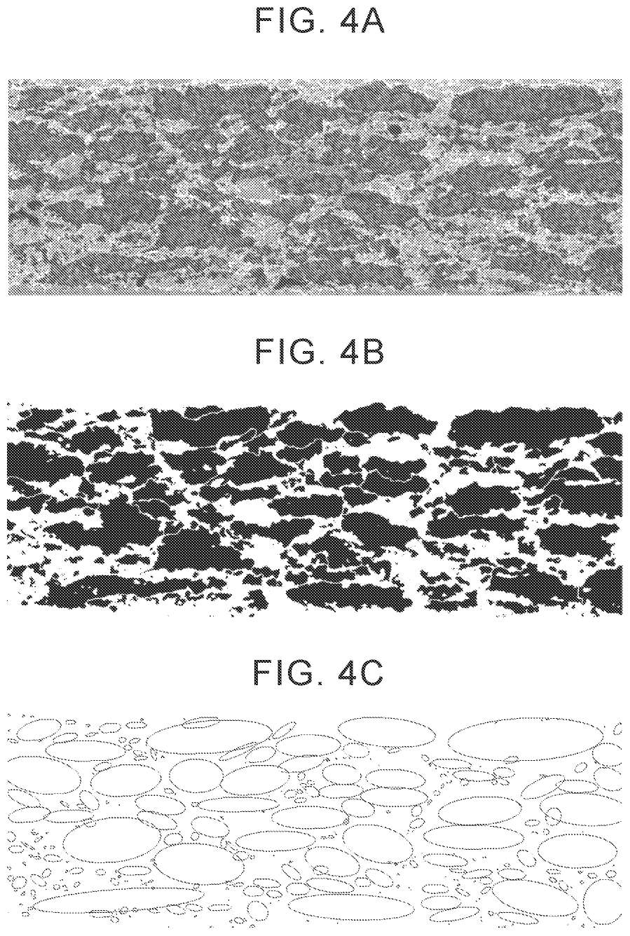

For Examples 1 and 2, the aspect ratio of the composite particles in the active material layer was measured. Specifically, cross-sectional images were obtained by observing the cross-section of the negative electrode with a SEM (FIG. 4A). In the observation field, 50 or more composite particles were observed. The obtained cross-sectional image was subjected to image analysis, and binarized with a portion of the composite particle (black) and a portion other than the composite particle (white) (FIG. 4B). In the cross-sectional image, the portions of the composite particles and the other portions were distinguished by elemental analysis or the like. In the binarized images, the parts of the composites (black) were elliptically approximated (FIG. 4C). Here, ImageJFiji was used as the image-analysis software, and the ellipse was approximated. For each elliptically approximated composite particle, its aspect ratio (major diameter/minor diameter) was measured.

On the other hand, in the binarized cross-sectional image, the composite particles included in the cross-section were extracted in descending order of the cross-sectional area. The extraction was terminated when the total area of the extracted composite particles exceeded 80% of the total area of all composite particles contained in the cross-sectional image. The proportion of the plurality of extracted composite particles having an aspect ratio of 2.5 or more was specified.

As a result, in Example 1, 57.1% (number ratio) of the plurality of composite particles extracted by the above method had an aspect ratio of 2.5 or more. Further, in Example 2, 50.4% (number ratio) of the plurality of composite particles extracted by the above method had an aspect ratio of 2.5 or more. According to the present inventor, when the active material mixture is pressed, the composite particles are deformed to increase the aspect ratio. In other words, in Examples 1 and 2, by pressing the composite particles to a degree having a predetermined aspect ratio, it is possible to reduce the contact resistance in the composite particles, the contact resistance between the composite particles, and the contact resistance between the composite particles and other materials, it is considered that it was possible to reduce the resistance of the negative electrode as a whole. From the results of Examples 1 and 2, when observing the cross-section of the active material layer, more than half of the plurality of composite particles extracted by the following extraction method, by having an aspect ratio of 2.5 or more, it is possible to suppress the constraint pressure increase amount small, it is considered that it is possible to further reduce the resistance.

Extraction method: The cross section of the active material layer is observed, the composite particles included in the cross section are extracted in descending order of the cross-sectional area, and the extraction is terminated when the total area of the extracted composite particles exceeds 80% of the total area of all the composite particles included in the cross section.

What is claimed is:

1. A secondary battery negative electrode comprising an active material layer, wherein:
the active material layer includes a sulfide solid electrolyte and a composite particle that serves as an active material;
the composite particle includes a plurality of porous silicon particles and a binder; and
the active material layer has a porosity of more than 15%.

2. The secondary battery negative electrode according to claim 1, wherein:
when a cross section of the active material layer is observed, at least half of a plurality of the composite particles extracted by the following extracting method has an aspect ratio of 2.5 or more.
Extraction method: The cross section of the active material layer is observed, the composite particles included in the cross section are extracted in descending order of a cross-sectional area, and the extraction is terminated when a total area of the extracted composite particles exceeds 80% of a total area of all the composite particles included in the cross section.

3. The secondary battery negative electrode according to claim 1, wherein the composite particle includes porous carbon serving as the binder.

4. A manufacturing method of a secondary battery negative electrode, the manufacturing method comprising:
acquiring a LiSi precursor including Li and Si;
removing Li from the LiSi precursor to acquire a porous silicon-particle;
acquiring a composite particle including a plurality of the porous silicon particles and a binder;
acquiring an active material mixture including a sulfide solid electrolyte and the composite particle; and
acquiring an active material layer having a porosity of more than 15% by pressing the active material mixture.

5. The manufacturing method according to claim 4, further comprising pressing the active material mixture to deform the composite particle, wherein
when a cross section of the active material layer after pressing is observed, at least half of a plurality of the composite particles extracted by the following extraction method has an aspect ratio of 2.5 or more.
Extraction method: The cross section of the active material layer is observed, the composite particles included in the cross section are extracted in descending order of a cross-sectional area, and the extraction is terminated when a total area of the extracted composite particles exceeds 80% of a total area of all the composite particles included in the cross section.

6. The manufacturing method according to claim 4, further comprising mixing the plurality of porous silicon particles with an organic component to acquire an intermediate complex, and
carbonizing the organic component of the intermediate complex to acquire the composite particle including the porous silicon particles and porous carbon serving as the binder.

7. A secondary battery comprising the secondary battery negative electrode according to claim 1.
